(19) United States
(12) Patent Application Publication
(10) Pub. No.: US 2005/0046118 A1
(43) Pub. Date: Mar. 3, 2005

(54) Seal structure for multi-cylinder internal combustion engine

(75) Inventors: Akira Yasuki, Toyota-shi (JP); Kazunari Takenaka, Toyota-shi (JP)

Correspondence Address: FINNEGAN, HENDERSON, FARABOW, GARRETT & DUNNER;LLP, 1300 I STREET, NW, WASHINGTON, DC, 20005, US

(73) Assignee: Toyota Jidosha Kabushiki Kaisha

(21) Appl. No.: 10/926,312

(22) Filed: Aug. 26, 2004

(30) Foreign Application Priority Data
Aug. 27, 2003 (JP) 2003-303503

(51) Int. Cl. F16J 15/32

(52) U.S. Cl. 277/591

(57) ABSTRACT

A gasket has seal portions at portions contacting peripheries of upper end portions of internal surfaces of cylinders, respectively. By being provided with a stopper, each of the seal portions is formed as a thick portion in the gasket. The stopper of each of the seal portions has a portion whose thickness is greater than a thickness of the stopper of each of the seal portions corresponding to cylinders at both ends of the cylinder alignment.

### INCORPORATION BY REFERENCE

The disclosure of Japanese Patent Application No. 2003-303503 filed on Aug. 27, 2003 including the specification, drawings and abstract is incorporated herein by reference in its entirety.

### BACKGROUND OF THE INVENTION

1. Field of the Invention

The invention relates to a seal structure for a multi-cylinder internal combustion engine, in which sealing is provided between a cylinder block and a cylinder head when the cylinder block and the cylinder head are fastened to each other with a bolt through a gasket.

2. Description of the Related Art

In a seal structure for an internal combustion engine, generally, there is provided a gasket having a seal portion at a portion contacting a periphery of an upper end portion of an internal surface of each cylinder. An example of such a seal portion is disclosed in “cylinder head gasket structure” in Toyota Technical Report No. 12434 issued on Jul. 31, 2001. This technical report discloses a gasket having a shim whose thickness is non-uniform, that is, the thickness is small in an area near a bolt with which a cylinder block and a cylinder head are fastened to each other, compared with the other area.

This technology is developed in order to address the following problem. Fastening a cylinder block and a cylinder head to each other through a gasket having a shim whose thickness is uniform causes a difference in a load applied to a periphery of an internal surface of a cylinder between an area near a bolt and the other area. The difference in the load causes deformation in the internal surface of the cylinder. Namely, by providing the above-mentioned shim having a non-uniform thickness, the pressure applied to the periphery of the internal surface of the cylinder can be uniformed, when the cylinder block and the cylinder head are fastened to each other with the bolt through the cylinder gasket. Therefore, the degree of roundness of the periphery of the internal surface of the cylinder can be increased, thus enhancing smoothness in movement of a piston ring along the internal surface of the cylinder. As a result, the consumption of fuel can be reduced.

As described so far, the degree of roundness of the periphery of the internal surface of the cylinder can be enhanced, by adjusting the thickness of the shim, in consideration of the fact that there is a difference in the pressure applied to the cylinder block between the area near the bolt and the other area when the cylinder block and the cylinder head are fastened to each other with the bolt through the cylinder gasket. However, even when such adjustment is made, there is a possibility that coaxiality among bearings for a crank journal of the cylinder block is reduced. This problem has been confirmed by the inventors. Also, reduction in coaxiality among the bearings may result in an increase in the friction between the crank journal and the bearings therefor, seizing up of the bearing, and the like.

Accordingly, with the conventional seal structure for an internal combustion engine, it is difficult to achieve both provision of sealing between the cylinder block and the cylinder head, and maintenance of the structure of an internal combustion engine in an appropriate state.

### SUMMARY OF THE INVENTION

It is an object of the invention to provide a seal structure for a multi-cylinder internal combustion engine, in which sealing can be provided between a cylinder block and a cylinder head more appropriately.

A first aspect of the invention relates to a seal structure for a multi-cylinder internal combustion engine, including a cylinder block; a cylinder head fitted to the cylinder block; and a gasket having a first seal portion which seals an upper end portion of each of cylinders at both ends of a cylinder alignment and a second seal portion which seals an upper end portion of each of the other the cylinders in the cylinder alignment, each of the first seal portion and the second seal portion being provided at a portion contacting a periphery of the upper end portion of an internal surface of the corresponding cylinder. The first seal portion and the second seal portion provide sealing between the cylinder block and the cylinder head, when the cylinder block and the cylinder head are fastened to each other with a bolt through the gasket. Also, forms of the first seal portion and the second seal portion are made different from each other.

In the first aspect, a load, which is applied through the seal portion by the bolt with which the cylinder block and the cylinder head are fastened to each other in an area other than areas at both ends of the cylinder block, is dispersed to the peripheries of the internal surfaces of the plural cylinders adjacent to the bolt. In contrast to this, a load, which is applied through the seal portion by the bolt with which the cylinder block and the cylinder head are fastened to each other at each of both ends of the cylinder block, is concentrated on the periphery of the internal surface of the cylinder at the ends of the cylinder alignment. Therefore, variation occurs between the load applied to the periphery of the internal surface of each of the cylinders at both ends of a cylinder alignment, and the load applied to the periphery of the internal surface of each of the other cylinders, in the cylinder block.

According to the first aspect, by providing the above-mentioned seal portions whose forms are different from each other, it is possible to appropriately apply the same load to the periphery of the internal surface of each of all the cylinders, while suppressing variation in the loads applied to the cylinders. Namely, it is possible to appropriately suppress the load applied to the periphery of the internal surface of each of the cylinders other than the cylinders at both ends of the cylinder alignment from being smaller than the load applied to the periphery of the internal surface of each of the cylinders at both ends of the cylinder alignment in the cylinder block. Therefore, the structure of the internal combustion engine can be appropriately maintained, for example, reduction in coaxiality among bearings for a crank journal due to variation in the loads can be appropriately suppressed. Accordingly, with the above-mentioned structure, it is possible to provide sealing between the cylinder block and the cylinder head more appropriately.

In the first aspect, the first seal portion and the second seal portion may be formed as thick portions in the gasket. Thus, the seal portions having excellent sealing performance can be obtained.

In the first aspect, a thickness of a thick portion of the second seal portion may be greater than a thickness of a thick portion of the first seal portion. In the thick portion, a portion having a large thickness is likely to be applied with a load generated by the bolt, compared with a portion having a small thickness. Therefore, by adjusting the thickness of the thick portion, it is possible to more appropriately suppress the load applied to the periphery of the internal surface of each of the cylinders other than cylinders at both ends of the cylinder alignment from being smaller than the load applied to the periphery of the internal surface of each of the cylinders at both ends of the cylinder alignment in the cylinder block.

In the first aspect, an average thickness of the thick portion of the second seal portion may be greater than an average thickness of the thick portion of the first seal portion. In the thick portion, the portion having a large thickness is likely to be applied with the load generated by the bolt, compared with the portion having a small thickness. Thus, by making the average thickness of the thick portion corresponding to each of the cylinders other than the cylinders at both ends of the cylinder alignment greater than the average thickness of the thick portion corresponding to each of the cylinders at both ends of the cylinder alignment in the cylinder block, it is possible to appropriately adjust variation in the loads applied to the peripheries of the internal surfaces of the cylinders through the thick portions.

A second aspect of the invention relates to a seal structure for a multi-cylinder internal combustion engine, including a cylinder block; a cylinder head fitted to the cylinder block; a gasket having a first seal portion which seals an upper end portion of each of cylinders at both ends of a cylinder alignment and a second seal portion which seals an upper end portion of each of the other the cylinders in the cylinder alignment, each of the first seal portion and the second seal portion being provided at a portion contacting a periphery of the upper end portion of an internal surface of the corresponding cylinder. As a distance between a cylinder and the both ends of the cylinder alignment in the cylinder block increases, an average thickness of a thick portion of the second seal portion corresponding to the cylinder increases.

In the second aspect, a distance between a bolt with which the cylinder block and the cylinder head are fastened to each other and the cylinder adjacent to the bolt decreases the closer the cylinder and the bolt are to the center of the cylinder block. Therefore, the load applied to the periphery of the internal surface of each cylinder by the bolt is more likely to be dispersed, as the distance between the bolt and the center of the cylinder block decreases. Accordingly, as a distance between a cylinder and the center of the cylinder block decreases, the load applied to the periphery of the internal surface of the cylinder by the bolt through the thick portion decreases.

According to the second aspect, as the distance between a cylinder and the both ends of the cylinder alignment in the cylinder block increases, the average thickness of the thick portion corresponding the cylinder increases. It is thus possible to appropriately apply the load generated by the bolts to the periphery of the internal surface of each of all the cylinders, while suppressing variation in the loads applied to the cylinders. Namely, it is possible to appropriately suppress the load applied to the periphery of the internal surface of the cylinder by the bolt through the thick portion from decreasing as the distance between the cylinder and the center of the cylinder block decreases. Therefore, the structure of the internal combustion engine can be appropriately maintained, for example, reduction in coaxiality among bearings for the crank journal due to variation in the loads can be appropriately suppressed. Accordingly, with the above-mentioned structure, it is possible to provide sealing between the cylinder block and the cylinder head more appropriately.

A third aspect of the invention relates to a seal structure for a multi-cylinder internal combustion engine, including a cylinder block; a cylinder head fitted to the cylinder block; and a gasket having a seal portion which seals an upper end portion of each of cylinders at a portion contacting a periphery of an internal surface of the cylinder. From the viewpoint of bolts adjacent to each of the cylinders, when a total number of cylinders adjacent to the bolts is obtained, shapes of the seal portions corresponding to the cylinders having different total numbers are made different from each other.

In the third aspect, the load applied by the bolt to the periphery of the internal surface of each of the cylinders adjacent to the bolt varies depending on the number of cylinders adjacent to the bolt. The load applied by the bolt through the seal portion is dispersed to the internal surfaces of the cylinders adjacent to the bolt.

According to the third aspect, by providing the seal portions having the above-mentioned structure, it is possible to apply the load to the periphery of the internal surface of each of all the cylinders more appropriately, while suppressing variation in the loads applied to the cylinders. Namely, it is possible to appropriately suppress the load applied by the bolt to the periphery of the internal surface of the cylinder through the seal portion from decreasing as the total number for the cylinder increases. Therefore, the structure of the internal combustion engine can be appropriately maintained, for example, reduction in coaxiality among bearings for the crank journal due to variation in the loads can be appropriately suppressed. Accordingly, with the above-mentioned structure, it is possible to provide sealing between the cylinder block and the cylinder head more appropriately.

In the third aspect, the seal portions may be formed as thick portions in the gasket.

In the third aspect, a thickness of a thick portion corresponding to the cylinder having a relatively large total number may be greater than a thickness of a thick portion corresponding to the cylinder having a relatively small total number. Thus, in the thick portion, a portion having a large thickness is likely to be applied with the load generated by the bolt, compared with a portion having a small thickness. Therefore, with the above-mentioned structure, by adjusting the thickness of the thick portions, it is possible to apply the load to the periphery of the internal surface of each of all the cylinders more appropriately, while suppressing variation in the loads applied to the cylinders.

In the third aspect, an average thickness of the thick portion corresponding to the cylinder having a relatively large total number may be greater than an average thickness of the thick portion corresponding to the cylinder having a relatively small total number. Thus, in the thick portion, the portion having a large thickness is likely to be applied with the load generated by the bolt, compared with the portion having a small thickness. Accordingly, with the above-mentioned structure, by making the average thickness of the thick portion corresponding to the cylinder having a relatively large total number greater than the average thickness of the thick portion corresponding to the cylinder having a relatively small total number, it is possible to appropriately adjust variation in the loads applied to the peripheries of the internal surfaces of the cylinders through the thick portions.

A fourth aspect of the invention relates to a seal structure for a multi-cylinder internal combustion engine, including a cylinder block; a cylinder head fitted to the cylinder block; a gasket which is provided between the cylinder block and the cylinder head, and which provides sealing between the cylinder block and the cylinder head when the cylinder block and the cylinder head are fastened to each other with a bolt; and a compensating member which is provided near an upper end portion of an internal surface of each of cylinders, and which compensates variation in loads applied by each bolt to a periphery of an internal surface of each of the cylinders adjacent to the bolt, in the case of bolts having different numbers of cylinders adjacent thereto.

In the fourth aspect, the load applied to the periphery of the internal surface of each of the cylinders adjacent to the bolt varies depending on the number of the cylinders adjacent to the bolt. The load applied by bolt through the thick portion is dispersed to the internal surfaces of the cylinders adjacent to the bolt.

According to the fourth aspect, by providing the compensating member, it is possible to apply the load to the periphery of the internal surface of each of all the cylinders more appropriately, while suppressing variation in the loads applied to the cylinders. Namely, it is possible to appropriately suppress the load applied to the periphery of the internal surface of the cylinder by the bolt from decreasing as the number of the cylinders adjacent to the bolt increases. Therefore, the structure of the internal combustion engine can be appropriately maintained, for example, reduction in coaxiality among bearings for the crank journal due to variation in the loads can be appropriately suppressed. Accordingly, with the above-mentioned structure, it is possible to provide sealing between the cylinder block and the cylinder head more appropriately.

The compensating member may be formed as the seal portion disclosed in any one of the above-mentioned three aspects. The total number of cylinders adjacent to bolts adjacent to a cylinder is obtained. Then, the compensating member may be formed by making the upper surface of the cylinder block higher as the total number for the cylinder relatively increases. Alternatively, the compensating member may be formed by making the bottom surface of the cylinder head lower as the total number for the cylinder relatively increases.

A fifth aspect of the invention relates to a seal structure for a multi-cylinder internal combustion engine, including a cylinder block; a cylinder head fitted to the cylinder block; a gasket which is provided between the cylinder block and the cylinder head, and which provides sealing between the cylinder block and the cylinder head when the cylinder block and the cylinder head are fastened to each other with a bolt; and compensating means provided near an upper end portion of an internal surface of each of cylinders, for compensating variation in loads applied by each bolt to a periphery of an internal surface of each of the cylinders adjacent to the bolt, in the case of bolts having different number of cylinders adjacent thereto.

In the fifth aspect, the load applied to the periphery of the internal surface of each of the cylinders adjacent to the bolt varies depending on the number of the cylinders adjacent to the bolt. The load applied by bolt through the thick portion is dispersed to the internal surfaces of the cylinders adjacent to the bolt.

According to the fifth aspect, by providing the compensating means, it is possible to apply the load to the periphery of the internal surface of each of all the cylinders more appropriately, while suppressing variation in the loads applied to the cylinders. Namely, it is possible to appropriately suppress the load applied to the periphery of the internal surface of the cylinder by the bolt from decreasing as the number of the cylinders adjacent to the bolt increases. Therefore, the structure of the internal combustion engine can be appropriately maintained, for example, reduction in coaxiality among bearings for the crank journal due to variation in the loads can be appropriately suppressed. Accordingly, with the above-mentioned structure, it is possible to provide sealing between the cylinder block and the cylinder head more appropriately.

### BRIEF DESCRIPTION OF THE DRAWINGS

The forgoing and further objects, features and advantages of the invention will become apparent from the following description of preferred embodiments with reference to the accompanying drawings, wherein like numerals are used to represent like elements and wherein:

FIG. 1 is a perspective view showing an entire structure of an embodiment, in which a seal structure for a multi-cylinder internal combustion engine according to the invention is applied to a seal structure for an in-line four-cylinder internal combustion engine; and

FIGS. 2A to 2D are views showing a structure of a gasket in the embodiment.

### DETAILED DESCRIPTION OF THE PREFERRED EMBODIMENTS

Hereafter, an embodiment, in which a seal structure for a multi-cylinder internal combustion engine according to the invention is applied to a seal structure for an in-line four-cylinder internal combustion engine, will be described with reference to accompanying drawings.

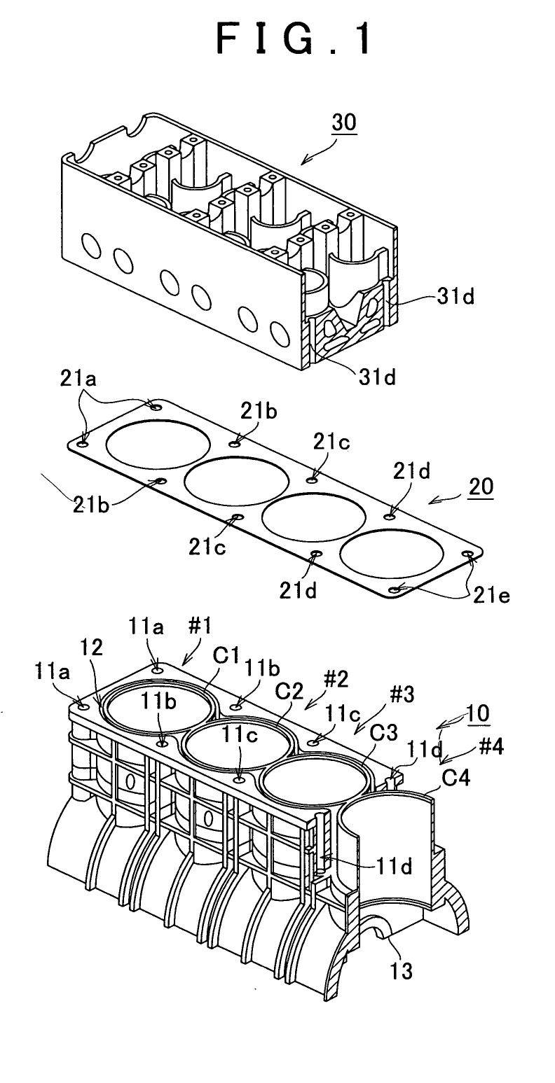

FIG. 1 shows an entire structure of a main portion of an internal combustion engine according to the embodiment. As shown in FIG. 1, the main portion of the internal combustion engine includes a cylinder block 10, a gasket 20, and a cylinder head 30.

The cylinder block 10 includes cylinders C1 to C4 which house pistons for cylinders #1 to #4, respectively. Between external surfaces of the cylinders C1 to C4 and an internal surface of the cylinder block 10, a water jacket 12 is formed. In the cylinder block 10, bearings 13 for a crank journal are formed at portions at both ends of a cylinder alignment and portions between the cylinders C1 and C2, cylinders C2 and C3, and cylinders C3 and C4. The bearings 13 are aligned at a lower portion of the cylinder block 10, in a direction substantially perpendicular to an axial direction of the cylinders C1 to C4. The cylinder block 10 is made of aluminum, and is formed in a die casting method. It is desirable that a cylinder liner (made of cast alloy, for example) be molded along the internal surface of each of the cylinders C1 to C4.

Bolt holes (11a to 11d in FIG. 1) are formed in the cylinder block 10. Bolt holes (21a to 21e in FIG. 1) are formed in the gasket 20. Bolt holes (31d in FIG. 1) are formed in the cylinder head 30. By inserting bolts into corresponding bolt holes, the cylinder block 10 and the cylinder head 30 are fastened to each other through the gasket 20.

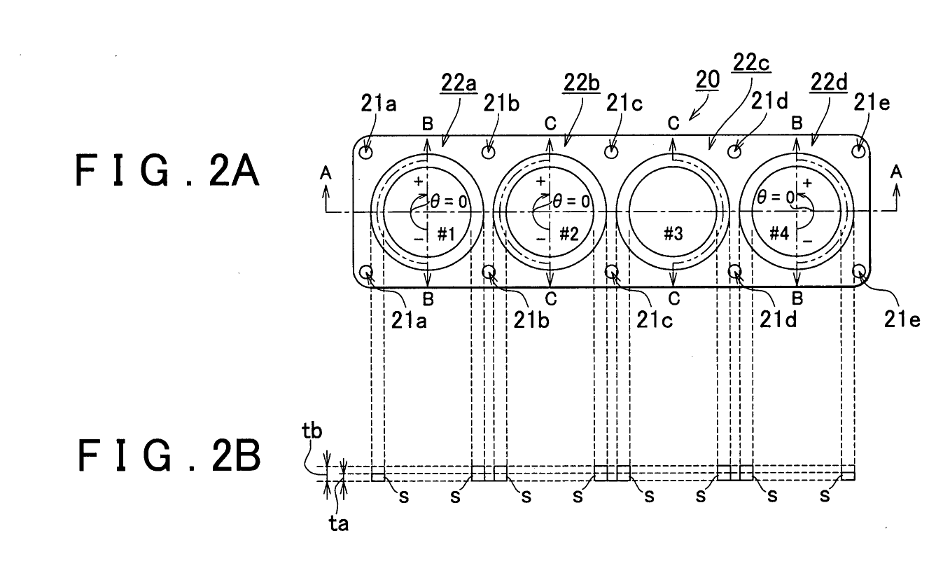

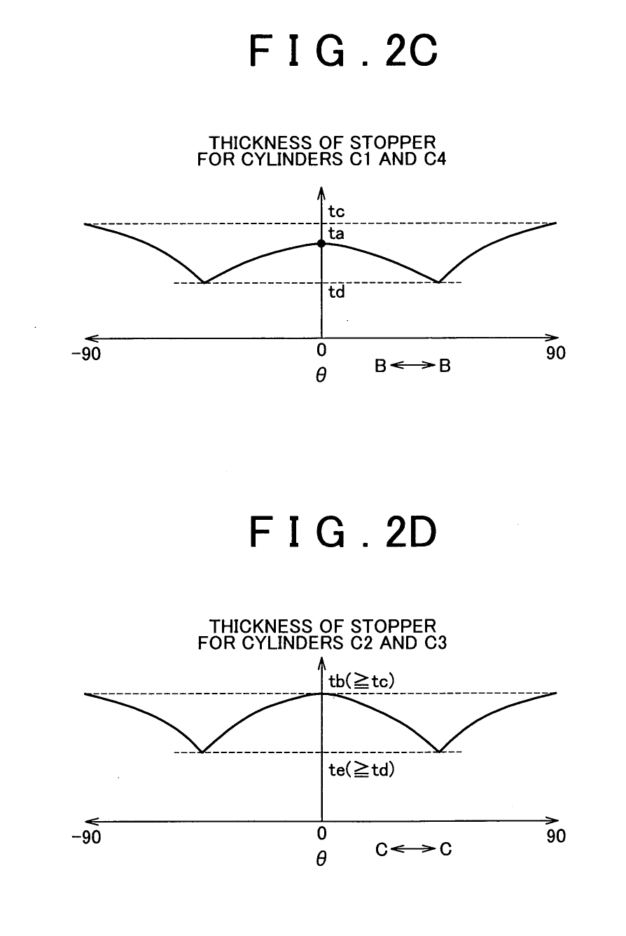

Hereafter, a structure of the gasket 20 will be described in detail with reference to FIGS. 2A to 2D.

As shown in FIG. 2A, the gasket 20 has seal portions 22a to 22d at portions which respectively contact peripheries of upper end portions of internal surfaces of the cylinders C1 to C4. FIG. 2B is a cross sectional view of FIG. 2A taken along line A-A, showing cross sections of stoppers “s” of the seal portions 22a to 22d. Since being provided with the stopper “S” having the cross section shown in FIG. 2B, each of the seal portions 22a to 22d is formed as a thick portion in the gasket 20. The stopper “s” is formed integrally with the gasket 20 by bending, welding, or the like. With this structure, when the cylinder block 10 and the cylinder head 30 are fastened to each other through the gasket 20, a pressure applied to a unit area between the cylinder block 10 and the seal portions 22a to 22d increases. As a result, it is possible to suppress leakage of combustion gas or the like from a combustion chamber provided to each of the cylinders C1 to C4.

Further, in the embodiment, the stopper “s” of each of the seal portions 22b and 22c corresponding respectively to the cylinders C2 and C3 is formed so as to have a portion whose thickness is greater than the thickness of the stopper “s” of each of the seal portions 22a and 22d corresponding respectively to the cylinders C1 and C4 at both ends of the cylinder alignment in the cylinder block 10. Namely, in the cross sectional view of FIG. 2A taken along line A-A, the thickness of the stopper “s” of each of the seal portions 22b and 22c is “tb”, while the stopper “s” of each of the seal portion 22a and 22d has a portion whose thickness is “ta” which is smaller than the thickness (tb).

More particularly, each of the seal portions 22a and 22d has the stopper “s” whose thickness is as shown in FIG. 2C, and each of the seal portions 22b and 22c has the stopper “s” whose thickness is as shown in FIG. 2D. FIG. 2C shows the thickness of the stopper “s” in the cross sectional view of FIG. 2A taken along line B-B. The position of the stopper “s” is defined by a parameter θ(−90≦θ≦90) shown in FIG. 2A. Here, the thickness of the stopper “s” of each of the cylinders C1 and C4 is “ta” at the position corresponding to “θ=0”, and “tc” at the position corresponding to “θ=±90”. Also, the minimum value of the thickness of the stopper “s” is “td”. FIG. 2D shows the thickness of the stopper “s” in the cross section of FIG. 2A taken along line C-C. The position of the stopper “s” is defined by a parameter θ(−90≦θ≦90). Here, the thickness of the stopper “s” of each of the cylinders C2 and C3 is “tb” (“tb”≧“tc”) at the position corresponding to “θ=0” and the position corresponding to “θ=±90”. Also, the minimum value of the thickness of the stopper “s” is “te” (“te”≧“td”).

As shown in FIGS. 2C and 2D, the thickness of the stopper “s” of each of the seal portions 22a to 22d increases as the distance between the stopper “s” and the adjacent bolts increases. However, the thickness of a certain portion of the stopper “s” of each of the seal portions 22b and 22c is greater than the thickness of a corresponding portion of the stopper “s” of each of the seal portions 22a and 22d. Accordingly, an average thickness of the thick portion corresponding to each of the cylinders C2 and C3 and is greater than an average thickness of the thick portion corresponding to each of the cylinders C1 and C4 at both ends of the cylinder alignment in the cylinder block 10. The corresponding portion is decided as follows. When the cylinder block 10 is substantially equally divided into two with respect to the line perpendicular to the direction in which the cylinders are aligned, two areas are obtained. In the case of the cylinders in the same area, the corresponding portions of cylinders are positioned at the same circumferential angle with respect to the line connecting the axes of the cylinders. In the case of the cylinders in the different areas, the corresponding areas are axisymmetircal to each other with respect to the line which is perpendicular to the line connecting the axes of the cylinders and which equally divides the line into two.

With such a structure, variation in the loads generated by the bolts, which are respectively applied to the internal surfaces of the cylinders C1 to C4 through the seal portions 22a to 22d, is suppressed. Accordingly, the loads generated by the bolts are applied to the peripheries of the internal surfaces of the cylinders C1 to C4 substantially uniformly.

The load generated by the bolt inserted into the each of the bolt holes 21b to 21d is dispersed to the peripheries of the internal surfaces of the plural cylinders adjacent to the bolt. For example, the load generated by the bolt inserted into the bolt hole 21c is dispersed to the peripheries of the internal surfaces of the cylinders C2 and C3. In contrast to this, the load generated by the bolt inserted into the bolt hole 21a is concentrated on the periphery of the internal surface of the cylinder C1. Thus, variation occurs between the load applied to the periphery of the internal surface of each of the cylinders C1 and C4 at both ends of the cylinder alignment in the cylinder block 10, and the load applied to the periphery of the internal surface of each of the other cylinders C2 and C3.

Particularly, in the embodiment, the cylinder block 10 is made of aluminum for the purpose of, for example, reducing the weight of the internal combustion engine. Since the Young's modulus of the aluminum is low, the internal combustion engine made of aluminum is likely to be deformed if there is variation in the loads generated by the bolts, which are applied to the peripheries of the upper portions of the internal surfaces of the cylinders through the seal portions. Especially, as shown in FIG. 1, the bearings 13 for the crank journal are formed at the portions at both ends of the cylinder alignment and the portions between the cylinders C1 and C2, cylinders C2 and C3, and cylinders C3 and C4, and the bearings 13 are aligned at a lower portion of the cylinder block 10, in a direction substantially perpendicular to an axial direction of the cylinders C1 to C4. Therefore, the loads generated by the bolts are likely to be applied to the bearings 13 through the seal portions 22a to 22d. Accordingly, if there is variation in the loads generated by the bolts, which are applied to the peripheries of the upper portions of the internal surfaces of the cylinders through the seal portions, coaxiality among the bearings 13 is likely to be reduced.

In the embodiment, however, through the use of the seal portions 22a to 22d, it is possible to appropriately suppress the load applied to the periphery of the internal surface of each of the cylinders C2 and C3 from being smaller than the load applied to the periphery of the internal surface of each of the cylinders C1 and C4 at both ends of the cylinder alignment in the cylinder block 10. Accordingly, it is possible to appropriately suppress reduction in coaxiality among the bearings 13 for the crank journal due to variation in the loads applied to the internal surfaces of the cylinders C1 to C4.

According to the embodiment described so far, the following effects can be obtained. (1) The average thickness of the thick portion corresponding to each of the cylinders C2 and C3 is greater than the average thickness of the thick portion corresponding to each of the cylinders C1 and C4 at both ends of the cylinder alignment in the cylinder block 10. It is thus possible to suppress variation in the loads generated by the bolts, which are respectively applied to the internal surfaces of the cylinders C1 to C4 through the seal portions 22a to 22d. Accordingly, it is possible to apply the loads generated by the bolts to the peripheries of the internal surfaces of the cylinders C1 to C4 substantially uniformly.

(2) By forming the seal portions 22a to 22d as the thick portions in the gasket 20, the seal portions having high sealing performance can be obtained. Note that modifications may be made to the above-mentioned embodiment as follows.

The structure of the thick portions, in which each of the thick portions corresponding to the cylinders other than the cylinders at both ends of the cylinder alignment has a portion whose thickness is greater than the thickness of each of the thick portions corresponding to the cylinders at both ends of the cylinder alignment, is not limited to the structure shown in the above-mentioned embodiment. Even in the case where another structure is employed, it is desirable that the thickness of a certain portion of the thick portion corresponding to each of the cylinders other than the cylinders at both ends in the cylinder alignment in the cylinder block be equal to or greater than the thickness of a corresponding portion of the thick portion corresponding to each of the cylinders at both ends of the cylinder alignment.

The method for making the forms of the thick portions different from each other between the seal portion corresponding to each of the cylinders at both ends of the cylinder alignment in the cylinder block and the seal portion corresponding to each of the other cylinders is not limited to adjustment of the average thickness of the thick portions. Namely, by appropriately adjusting the forms of the thick portions, the load applied to the periphery of the internal surface of each of the cylinders other than cylinders at both ends of the cylinder alignment in the cylinder block needs to be appropriately suppressed from being smaller than the load applied to the periphery of the internal surface of each of the cylinders at both ends of the cylinder alignment.

The seal portion which contacts the periphery of the upper end portion of the internal surface of the cylinder is not limited to the seal portion formed as the thick portion in the gasket. For example, the seal portion may be formed of a bead or the like. Even in such a case, by making the forms of the seal portions different from each other between the seal portion corresponding to each of the cylinders at both ends of the cylinder alignment in the cylinder block and the seal portion corresponding to each of the other cylinders, the load applied to the periphery of the internal surface of each of the cylinders other than the cylinders at both ends of the cylinder alignment in the cylinder block is be appropriately suppressed from being smaller than the load applied to the periphery of the internal surface of each of the cylinders at both ends of the cylinder alignment.

The arrangement of the bolts with which the cylinder bock and the cylinder head are fastened to each other through the gasket is not limited to the arrangement shown in the embodiment. Even when another arrangement is employed, the loads applied to the peripheries of the internal surfaces of the cylinders can be appropriately adjusted in the following method. Each cylinder has a plurality of bolts adjacent thereto. Each of the plurality of bolts has at least one cylinder adjacent thereto. If any given cylinder is counted once for each bolt adjacent thereto, then with a cylinder block having only one cylinder with four bolts around it, for example, that one cylinder is counted four times (in this case, once for each bolt). Therefore, in a case in which there are two cylinders in a cylinder block with two bolts on either end and two bolts between the two cylinders, there is theoretically one cylinder for each of the bolts on the ends, but two cylinders for each bolt in between because each of those bolts is adjacent to both (i.e., two) of the cylinders. Thus, from the viewpoint of four bolts around any one of the two cylinders, there are theoretically six cylinders. Similarly, when there are three cylinders in a cylinder block with one pair of bolts on either end and one pair of bolts between each end cylinder and the middle cylinder (i.e., a total of eight bolts), each of the bolts adjacent to the middle cylinder is adjacent to two cylinders (i.e., the middle cylinder and an end cylinder). Therefore, from the viewpoint of the four bolts adjacent to the middle cylinder, there are theoretically eight cylinders, while from the viewpoint of the four bolts adjacent to either of the end cylinders, there are theoretically six cylinders. In this way, the total number of theoretical cylinders adjacent to the plurality of bolts is then obtained from the viewpoint of those bolts. As described in the example above, that total number varies depending on the position of the cylinder (i.e., depending on whether the cylinder is located on the end of the cylinder block or between two cylinders). The shapes of the seal portions corresponding to the cylinders having different theoretical total numbers are made different. It is thus possible to appropriately suppress the load generated by the bolts, which is applied to the periphery of the internal surface of the cylinder through the seal portion, from decreasing as the theoretical total number which the cylinder has increases. For example, in FIG. 1, from the viewpoint of the bolts (the bolts inserted in the bolt holes 21a and 21b) adjacent to the cylinder 1, the theoretical total number of cylinders adjacent to the bolts is “6”. Also, in FIG. 1, from the viewpoint of the bolts (the bolts inserted in the bolt holes 21b and 21c) adjacent to the cylinder 2, the theoretical total number of cylinders adjacent to the bolts is “8”. The theoretical number of cylinders adjacent to the bolt inserted in each bolt hole 21a is “1”, and the theoretical number of cylinders adjacent to the bolt inserted in each bolt hole 21b or each bolt hole 21c is “2”.

The theoretical number of cylinders adjacent to the bolt varies depending on the position of the bolt. Depending on the theoretical number of cylinders, the load generated by the bolt, which is applied to the periphery of the internal surface of each cylinder adjacent the bot varies. In the above-mentioned example, as means for compensating variation in the loads, the seal portion is used. However, the compensating means is not limited to the seal portion.

The internal combustion engine is not limited to an internal combustion engine made of aluminum in die casting method. The inline engine is not limited to an in-line four-cylinder engine. Further, the internal combustion engine is not limited to an in-line engine, and may be a V-type engine, or the like. Even in the case where an engine other than the engine in the above-mentioned embodiment is used, each of the cylinders at both ends of the cylinder alignment in the cylinder block is adjacent to bolts each of which has relatively small theoretical number of cylinders adjacent to the bolt. Accordingly, it is effective to apply the invention for reducing variation in the loads applied to the internal surfaces of the cylinders.

1. A seal structure for a multi-cylinder internal combustion engine, comprising:
a cylinder block;
a cylinder head fitted to the cylinder block; and
a gasket having a first seal portion which seals an upper end portion of each of cylinders at both ends of a cylinder alignment and a second seal portion which seals an upper end portion of each of the other the cylinders in the cylinder alignment, each of the first seal portion and the second seal portion being provided at a portion contacting a periphery of an upper end portion of an internal surface of the corresponding cylinder, wherein:
the first seal portion and the second seal portion provide sealing between the cylinder block and the cylinder head, when the cylinder block and the cylinder head are fastened to each other with a bolt through the gasket; and
forms of the first seal portion and the second seal portion are made different from each other.

2. The seal structure according to claim 1, wherein the first seal portion and the second seal portion are formed as thick portions in the gasket.

3. The seal structure according to claim 2, wherein a thickness of a thick portion of the second seal portions is greater than a thickness of a thick portion of the first seal portion.

4. The seal structure according to claim 2, wherein an average thickness of a thick portion of the second seal portion is greater than an average thickness of a thick portion of the first seal portion.

5. A seal structure for a multi-cylinder internal combustion engine, comprising:
a cylinder block;
a cylinder head fitted to the cylinder block; and
a gasket having a first seal portion which seals an upper end portion of each of cylinders at both ends of a cylinder alignment and a second seal portion which seals an upper end portion of each of the other the cylinders in the cylinder alignment, each of the first seal portion and the second seal portion being provided at a portion contacting a periphery of an upper end portion of an internal surface of the corresponding cylinder, wherein as a distance between a cylinder and the both ends of the cylinder alignment in the cylinder block increases, an average thickness of a thick portion of the second seal portion corresponding to the cylinder increases.

6. A seal structure for a multi-cylinder internal combustion engine, comprising:
a cylinder block;
a cylinder head fitted to the cylinder block; and
a gasket having seal portions each of which seals an upper end portion of each of cylinders at a portion contacting a periphery of an upper end portion of an internal surface of each of the cylinders, wherein from the viewpoint of the bolts adjacent to each of the cylinders, when a total number of cylinders adjacent to the bolts is obtained, forms of the seal portions corresponding to the cylinders having different total numbers are made different from each other.

7. The seal structure according to claim 6, wherein the seal portions are formed as thick portions in the gasket.

8. The seal structure according to claim 7, wherein a thickness of a thick portion corresponding to the cylinder having a relatively large total number is greater than a thickness of a thick portion corresponding to the cylinder having a relatively small total number.

9. The seal structure according to claim 7, wherein an average thickness of a thick portion corresponding to the cylinder having a relatively large total number is greater than an average thickness of a thick portion corresponding to the cylinder having a relatively small total number.

10. A seal structure for a multi-cylinder internal combustion engine, comprising:
a cylinder block;
a cylinder head fitted to the cylinder block;
a gasket which is provided between the cylinder block and the cylinder head, and which provides sealing between the cylinder block and the cylinder head when the cylinder block and the cylinder head are fastened to each other with a bolt; and
a compensating member which is provided near an upper end portion of an internal surface of each of cylinders, and which compensates variation in loads applied by each bolt to a periphery of an internal surface of each of the cylinders adjacent to the bolt, in the case of bolts having different numbers of cylinders adjacent thereto.

11. The seal structure according to claim 10, wherein the compensating member is a seal portion which seals the upper end portion of the cylinder at a portion contacting the periphery of the upper end portion of the internal surface of the cylinder.

12. The seal structure according to claim 10, wherein in a case of the bolts adjacent to each of the cylinders, when the total number of the cylinders adjacent to the bolts is obtained, the compensating member is formed by making an upper surface of the cylinder block higher as the total number for the cylinder relatively increases.

13. The seal structure according to claim 10, wherein from the viewpoint of the bolts adjacent to each of the cylinders, when the total number of the cylinders adjacent to the bolts is obtained, the compensating member is formed by making a bottom surface of the cylinder head lower as the total number for the cylinder relatively increases.

14. The seal structure for a multi-cylinder internal combustion engine, comprising:
a cylinder block;
a cylinder head fitted to the cylinder block;
a gasket which is provided between the cylinder block and the cylinder head, and which provides sealing between the cylinder block and the cylinder head when the cylinder block and the cylinder head are fastened to each other with a bolt; and
a compensating means provided near an upper end portion of an internal surface of each of cylinders, for compensating variation in loads applied by each bolt to a periphery of an internal surface of each of the cylinders adjacent to each bolt, in the case of bolts having different numbers of cylinders adjacent thereto.
